(19) United States
(12) Patent Application Publication
(10) Pub. No.: US 2007/0023474 A1
(43) Pub. Date: Feb. 1, 2007

(54) Clincher for a heavy duty stapler

(76) Inventors: Robert Stevenson Smith, Bend, OR (US); Louis Liu, Bao An Shen Zhen (CN); Tony Tang, Bao An Shen Zhen (CN); Anthony Jairam, Sunrise, FL (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/473,598

(22) Filed: Jun. 22, 2006

Related U.S. Application Data
(60) Provisional application No. 60/699,788, filed on Jul. 14, 2005.

(51) Int. Cl. B25C 7/00

(52) U.S. Cl. 227/155; 227/154

(57) ABSTRACT

A stapler includes a driver to push a staple into a workpiece and a pair of clincher plates that are rotated by a clincher transmission, in coordination with movement of the driver, to clinch the staple.

### CROSS-REFERENCE TO RELATED APPLICATIONS

This application claims the benefit of U.S. Provisional Application No. 60/699,788, filed Jul. 14, 2005.

### BACKGROUND OF THE INVENTION

The present invention relates to a stapler and, more particularly to a clincher for a heavy duty stapler.

A staple is a two pronged, U-shaped fastener that is usually produced by bending a wire to form two legs that project normal to the respective ends of the staple's crown. For easier handling and loading into a mechanical stapler, staples are commonly abutted, side-to-side, and glued together to form long, channel shaped strips.

Staples are commonly used to join or bind together sheets of material, such as paper. A portion of a workpiece, comprising a stack of sheets to be bound together, is inserted between a magazine assembly and an anvil of a stapler. The workpiece is typically compressed between the magazine and the anvil before a driver, slidable in the magazine assembly and arranged to engage the crown of a staple at an end of a strip of staples retained in the magazine, is forced downward by manual or mechanical force. The downward movement of the driver breaks the first staple from the strip and forces the ends of its legs to penetrate and pierce the workpiece. The legs of the staple can be allowed to protrude from the reverse side of a workpiece but are typically bent approximately parallel to the crown or clinched to provide greater binding force than would be available from the friction between the workpiece and the straight legs of the staple.

Typically, staples are clinched by forcing the ends of the legs against the anvil until the columnar legs buckle. When the legs of the staple erupt from the reverse side of the workpiece, the ends of the legs engage the surfaces of a groove formed in the surface of the anvil. When sufficient force is exerted on the crown of the staple by the driver, the legs of the staple buckle. Continued movement of the driver pushes the crown toward the upper surface of the workpiece and bends the legs until they are generally parallel to the staple's crown.

Heavy duty staples used to bind many sheets or heavier sheets of material typically comprise a heavier gauge wire so that the legs of the staple will be sufficiently strong to penetrate the workpiece without buckling. Bending of the stronger legs of a heavy duty staple is less predictable and greater force is required, increasing the force required to operate the stapler and potentially making the stapler unstable. What is desired, therefore, is a clincher for a stapler enabling reliable clinching of heavy duty staples with the exertion minimal effort.

### BRIEF DESCRIPTION OF THE DRAWINGS

FIG. 1 is a partially broken away, elevation view of a stapler.

FIG. 2 is an elevation view of the stapler of FIG. 1 illustrating initial rotation of the magazine assembly.

FIG. 3 is a partial elevation view of the stapler of FIG. 1 illustrating movement of the clincher drive plate to depress the clincher slide.

FIG. 4 is a partial elevation view of the stapler of FIG. 1 illustrating displacement of the clincher slide enabling return of the clincher driver to an initial position.

FIG. 5 is a section view of the anvil of the stapler with the clincher plates in the clinched position taken along line 5-5 of FIG. 1.

FIG. 6 is a section view of the anvil of the stapler with the clincher plates in the unclinched position taken along line 5-5 of FIG. 1.

FIG. 7 is a section view of the anvil and a clinched staple taken along line 5-5 of FIG. 1.

FIG. 8 is a top view of a portion of the anvil of the stapler of FIG. 1 taken along line 8-8.

### DETAILED DESCRIPTION OF PREFERRED EMBODIMENTS

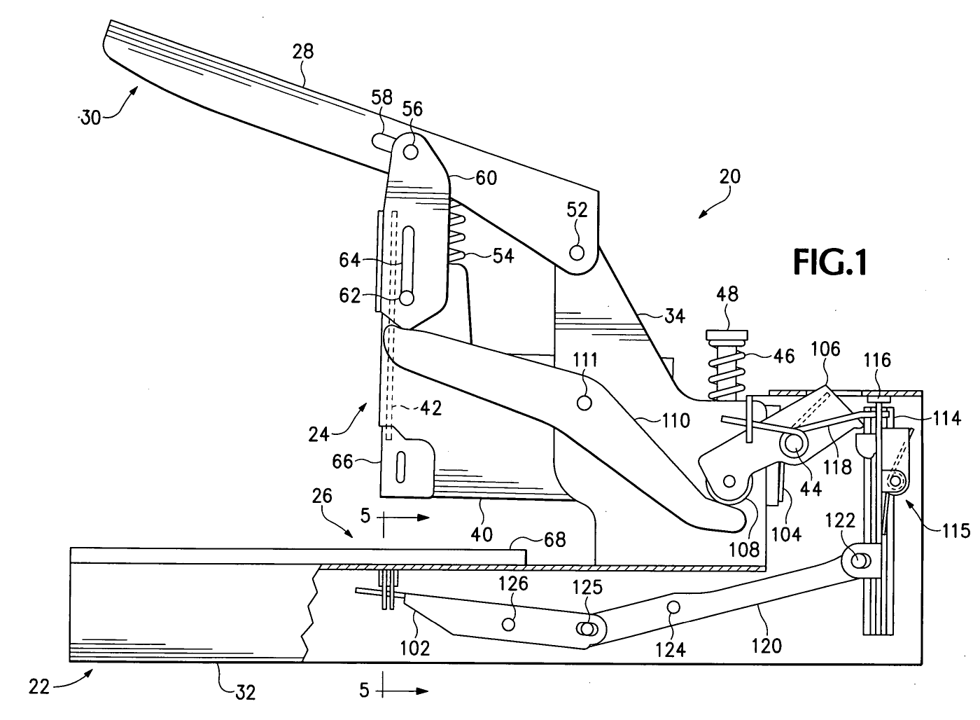

Referring in detail to the drawings where similar parts are identified by like reference numerals, and, more particularly to FIG. 1, a heavy duty stapler 20 comprises generally a base assembly 22; a magazine assembly 24, pivotally attached to the base assembly; an anvil assembly 20 attached to the base assembly; and a handle 28 that is pivotally attached to the base assembly and which includes a hand grip portion 30 for engagement by the user when applying manual force to actuate the stapler.

The base assembly 22 comprises a lower base 32 having a base surface arranged to support the stapler on a supporting surface, such as a table or a counter top, and an upper base 24. The upper base comprises a generally U-shaped plate including a pair of spaced apart vertically projecting side plates and a web that connects the side plates and which is fastened to the lower base by screws.

The magazine assembly 24 comprises generally a magazine 40 that includes provisions for retaining a strip of staples and a driver 42 that is operatively connected to the handle. The driver is arranged to impinge on the crown of a staple at the end of a strip of staples in the magazine and push the staple out of the magazine. The magazine includes a portion that is arranged between the vertically projecting side plates of the upper base and pivotally restrained to the side plates by a magazine pin 44. A counterbalance spring 46, compressed between a portion of the magazine and the head of a pin 48 that is affixed to the base, elastically counterbalances the weight of the magazine and urges the magazine to pivot upward to a position where the lower surface of the magazine is supported above the anvil assembly 26 and the lower base so that a portion of a workpiece, such as a stack of sheets of paper, can be inserted between the lower surface of the magazine and the anvil assembly.

The handle 28 is pivotally attached to the base at one end by a handle pin 52. A handle spring 54 located between the handle and the magazine assembly elastically urges the hand grip portion 30 of the handle to rotate upward. The driver 42 is slidably arranged adjacent to the inside of the front surface of the magazine and is attached to the handle by a driver pin 56 that engages co-located slots 58 in the sides of the U-shaped cross-section of the handle. The driver pin also secures a transmission drive plate 60 to the handle. The transmission drive plate has a generally U-shaped cross-section with a web having an inner surface that is arranged adjacent to the exterior, front surface of the magazine and a pair of side plates that extend substantially normal to the web along the exterior surfaces of the sides of the magazine. The transmission drive plate is slidably restrained to the magazine by a drive plate pin 62 that projects from either side of the magazine and is slidably movable in a slot 64 in the each of side plates of the transmission drive plate.

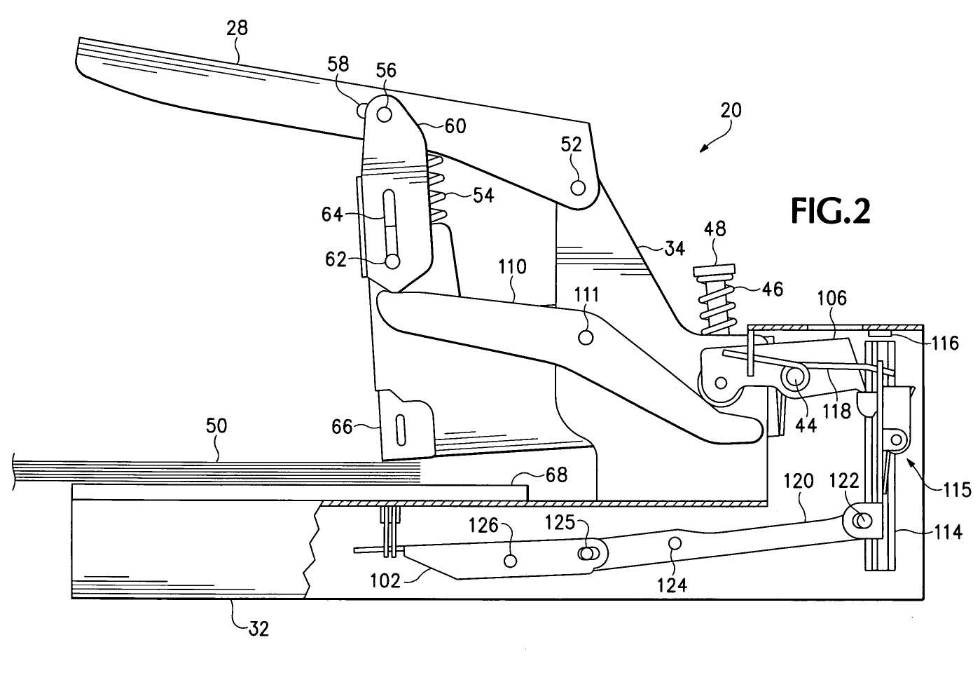

Referring to FIG. 2, when the user pushes downward on the hand grip portion 30 of the handle 28, the force of the counterbalance spring 46 is overcome and the magazine pivots downward around the magazine pin 44 until a nosepiece 66 attached to the magazine compresses a workpiece 50 resting on a workpiece supporting surface 68 comprising, generally, portions of the anvil assembly 26 and the lower base 32. The compressive force exerted by the nosepiece on the workpiece increases with further displacement of the handle by the user. When the elastic force exerted on the handle by the handle spring is overcome, further displacement of the handle moves the driver 42 and the transmission drive plate 60 downward relative to the magazine.

A strip of staples is retained in a channel assembly that is slidably arranged in the magazine. The strip of staples comprises a plurality of staples, each staple comprising a crown and a leg arranged normal to the crown at each of its ends, which are abutted, side-to-side, and bonded together, typically with an adhesive, to form an open sided channel. A latch engageable with the channel assembly retains the channel assembly in the magazine until released to permit insertion of a strip of staples. The channel assembly comprises a channel having a base and sides projecting normally from the base. One end of the channel is enclosed by the U-shaped nosepiece 66 that is affixed to the sides of the channel but leaves a gap between the interior surface at the front of the nosepiece and the end of the base of the channel through which a staple can pass when pushed from magazine by the driver.

A strip of staples is inserted into the channel assembly with the crown uppermost and the free ends the legs pointed downward. A spring loaded plunger, slidable in the channel assembly urges the strip of staples toward the inner front surface of the nosepiece 66 which is arranged substantially co-planar with the inner front surface of the magazine. When the driver is forced downward by movement of the handle, a lower surface of the driver impinges on the crown of the staple nearest the inner surface of the nosepiece. The bond between the staple and its neighboring staple in the strip is broken and the staple is separated from the remaining staples of the strip. However, the spring loaded plunger in the channel urges the strip of staples to continue to bear on the side of the separated staple urging continued contact with the inner surface of the nosepiece to guide the staple as the driver continues to move downward. The ends of the staple's legs are pushed into the upper surface of a workpiece which is compressed between the magazine and the workpiece supporting surface.

Referring to FIGS. 5 and 8, the anvil assembly 26 comprises a pair of outer anvil plates 80 and a central anvil plate 82. Projections extending from the outer and central anvil plates engage corresponding apertures in an anvil retainer is secured in the lower base by screws. The upper surfaces of the outer and central anvil plates are arranged substantially co-planar forming a portion of the workpiece supporting surface. A clincher plate 86 is disposed between each of the outer anvil plates 80 and the central anvil plate 82, spacing the respective outer anvil plate apart from the central anvil plate. The outer and central anvil plates are secured to the lower base 32 at an angle to the front surface of the nosepiece 66 so that each of the legs of a staple pushed from the magazine will be aligned with a respective space between the central anvil plate and one of the outer anvil plates.

Each clincher plate 86 is pivotally supported between an outer anvil plate and the central anvil plate by a clincher plate pin 88 that engages the central anvil plate, the respective clincher plate and the adjacent outer anvil plate. The clincher plates each comprise a clinching surface 90 arranged to engage a leg of a staple protruding from the lower surface of a workpiece and into the gap between the respective outer anvil plate and the central anvil plate, a clinching cam surface 92 and a retraction cam surface 94. An end portion of a transmission lever 102 is arranged to engage, alternatively, the clinching cam surfaces and the retraction cam surfaces of the clincher plates.

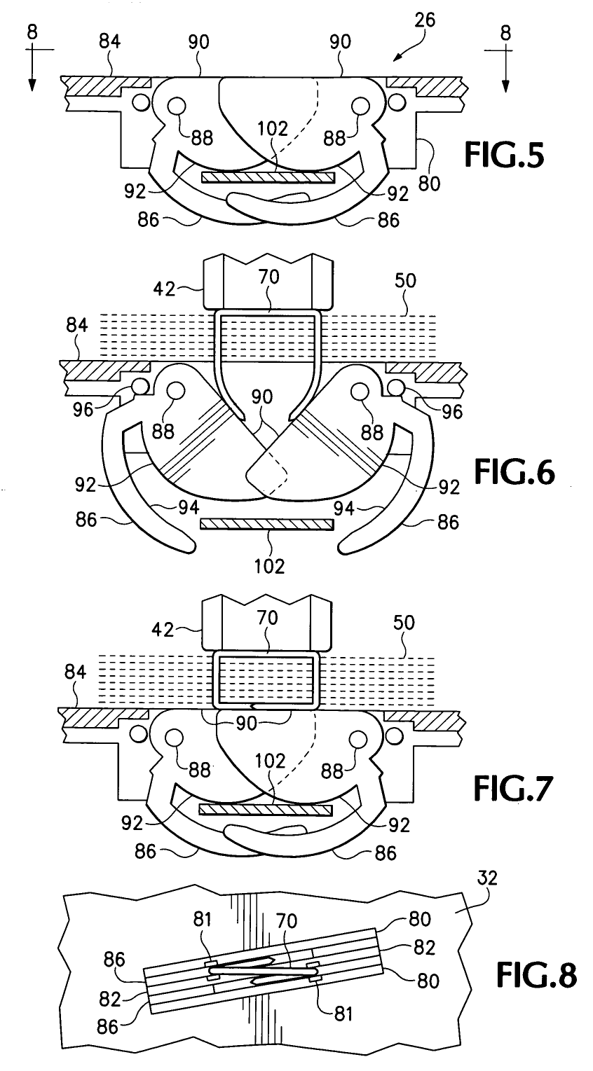

Referring to FIG. 6, when the end portion of the transmission lever 102 is displaced downward, the clincher plate 86 is permitted to rotate about the clincher plate pin 88 or, if necessary, is forced to rotate by interaction of the lever and the retraction cam surface 94 to the unclinched position. The clincher plate rotates until a stop pin surface on the clincher plate contacts a stop pin 96 affixed to at least one of the outer and central anvil plates. When the clincher plate rotates downward to the unclinched position, the clinching surface 90 is rotated at an acute angle below the upper surfaces of the outer and central anvil plates exposing gaps in the workpiece supporting surface bounded by the central anvil plate and the respective outer anvil plate. Portions 81 of the central and outer anvil plates form ramp surfaces to guide the ends of a staple's legs into the respective gaps in the workpiece supporting surface. Rotation of the clincher surfaces to the unclinched position permits the legs of a staple erupting from the lower surface of a workpiece due to the impetus of the moving driver to project into the respective spaces between the central and outer anvil plates where portions of the legs are engageable by the clinching surfaces 90 of the clincher plates.

Referring to FIG. 7, when the end portion of the transmission lever 102 is displaced upward, its upper surface engages the clinching cam surface 92 rotating the clincher plate 86, including the clinching surface 90 about the clincher plate pin. At the upper limit of displacement of the end portion of the transmission lever, the clinching surfaces 90 have rotated to a clinched position where the clinching surfaces are aligned substantially parallel with the upper surfaces of the outer and central anvil plates. In the clinched position the clinching surfaces are preferably substantially co-planar with upper surfaces of the anvil plates forming a substantially planar workpiece supporting surface and preventing loose staples or other debris that might interfere with operation of the clincher from entering the anvil assembly. The leg of a staple protruding into the space between the central anvil plate and one of the outer anvil plates will be bent toward the center of the crown and back toward the lower surface of the workpiece, or clinched, by rotation of the clinching surface from the unclinched position to the clinched position.

Before a stapling cycle is initiated, the magazine is supported above the anvil assembly and the lower base by the counterbalance spring and a workpiece 50 to be stapled, such as a stacked plurality of sheets of paper, can be inserted between the lower surface of the magazine and the anvil assembly. The handle spring bearing between the handle and the magazine assembly elastically urges the hand grip portion of the handle to rotate upward and the driver pin 56, connecting the driver 42 and the transmission drive plate 60 to the handle, pulls the driver and the transmission drive plate upward until the drive plate pins 62 engage the bottom of the slots in the transmission drive plate. A clinch driver return spring 104 engaging a clinch driver lever 106, pivotally mounted on the base by the magazine pin 44, rotates the clinch drive lever to an initial position. A roller 108 attached to one end of the clinch driver lever bears on a surface at one end of a transmission plate 110 that is pivotally mounted on the base by a transmission plate pin 111. The transmission plate is rotated by the force exerted by the roller forcing the second end of the transmission plate upward into contact with a lower surface of the transmission drive plate 60.

A clinch slide 115 comprising a clinch slide plate 117, slidably mounted in clinch slide guides 114 attached to the base, is urged upward to an initial position in contact with a clinch slide stop 116 by clinch slide springs 118 located on either side of the base. The clinch slide springs are torsion springs comprising a coil supported by the magazine pin 44 and ends that engage, respectively, the base and apertures in the clinch slide plate. Other types of springs and the energy storage devices could be used to store energy and urge the clinch slide to the initial position.

The clinch slide 115 is pivotally connected to a first end portion of an idler lever 120 by a clinch slide pin 122. The idler lever is pivotally mounted to the base, approximately intermediate between the ends of the lever, by an idler fulcrum pin 124 and the upward displacement of the clinch slide rotates the second end portion of the idler lever downward. The second end portion of the idler lever is pivotally connected by a connector pin 125 to a first end portion of the transmission lever 102 which is pivotally mounted to the base 22 by a transmission lever fulcrum pin 126. The downward displacement of the second end portion of the idler lever produces upward displacement of the second end portion of the transmission lever. The upper surface of the second end portion of the transmission lever bears against the clinching cam surfaces 92 of the clincher plates 86 and, initially, rotate the clincher plates upward to the clinched position.

To initiate the stapling cycle, the user pushes the hand grip downward. The elastic force of the counterbalance spring is overcome by the weight of the magazine and the downward force exerted on the handle. The magazine is forced to rotate downward, compressing the workpiece 50 between the nosepiece 66 and the anvil assembly 26. Since the rotational position of the handle relative to the magazine is unchanged, the clincher plates are not moved from their initial position.

When the compressive force exerted on the workpiece 50 is sufficient to overcome the elastic force exerted by the handle spring 54, further displacement of the hand grip 30, produced by exertion of additional force by the user, causes the handle to rotate relative to the magazine. As a result of their common attachment to the handle by the driver pin 56, downward rotation of the handle relative to the magazine simultaneously displaces the driver 42 and the transmission plate driver 60 downward. When the driver moves downward, the lower surface of the driver impinges on the crown of a staple, separating the staple from the strip of staples stored in the magazine. The staple is pushed out of the magazine and the ends of the staple's legs are forced to pierce the workpiece supported on the workpiece supporting surface.

The lower surface of a side wall of the transmission plate driver bears on a portion of the peripheral surface of the first end of the transmission plate 110 located on either side of the base. Downward movement of the first end portion of the transmission plate causes upward movement of the second end portion of the transmission plate which engages the transfer roller 108 rotationally mounted on the first end of the clinch driver lever 106. The transfer roller reduces friction between the transmission plate and the clinch driver lever to smooth the transfer of force and motion to the clinch driver lever and reduce the force required to actuate the stapler.

Upward displacement of the transfer roller due to movement of the transmission plate causes the clinch driver lever to rotate clockwise. A portion 150 of the peripheral surface of the clinch driver lever 106 is arranged to bear on a first contact surface 153 of a return plate 152 that is pivotally attached to the clinch slide plate 117 by a hinge pin 154. The return plate comprises a first portion and a second portion that is arranged substantially normal to the first portion and includes the first contact surface 153,. The force exerted on the first contact surface 153 causes the hinged first portion of the return plate to bear on the reverse surface of the clinch slide plate and the clockwise rotation of the clinch driver lever forces the clinch slide 115 to translate downward in the clinch slide guides 114.

Downward displacement of the clinch slide moves the first end portion of the idler lever 120 downward causing upward movement of the second end portion of the idler lever and the first end portion of the transmission lever 102. Upward displacement of the first end portion of the transmission lever produces downward movement of the second end portion of the transmission lever and the withdrawal of support for the clinching cam surfaces 92 of the clincher plates 86. Gravity urges rotation of the clincher plates but, if the gravitational force is insufficient, the interaction of the lower surface of the end portion of the transmission lever and the retraction cam surfaces 94 of the clincher plates forces the clincher plates to rotate downward to the unclinched position so that the clinching surfaces are depressed below and at an angle to the upper surfaces of the outer and central anvil plates creating, in coordination with the piercing of the workpiece by the staple's legs, two gaps in the workpiece supporting surface into which the legs of the staple can protrude when they are pushed through the bottom surface of the workpiece by continued movement of the driver. Referring to FIG. 6, when the legs of the staple erupt from the workpiece and enter the respective spaces between the anvil plates, the leg of the staple moves into a position where a portion can be engaged by the clinching surface 90. If the workpiece is thin enough, the ends of the staple's legs may protrude through the workpiece far enough to contact the clinching surfaces and, as the driver nears the limit of its downward travel, the ends of the legs may be bent slightly toward the center of the crown by interaction with the angled clincher surfaces.

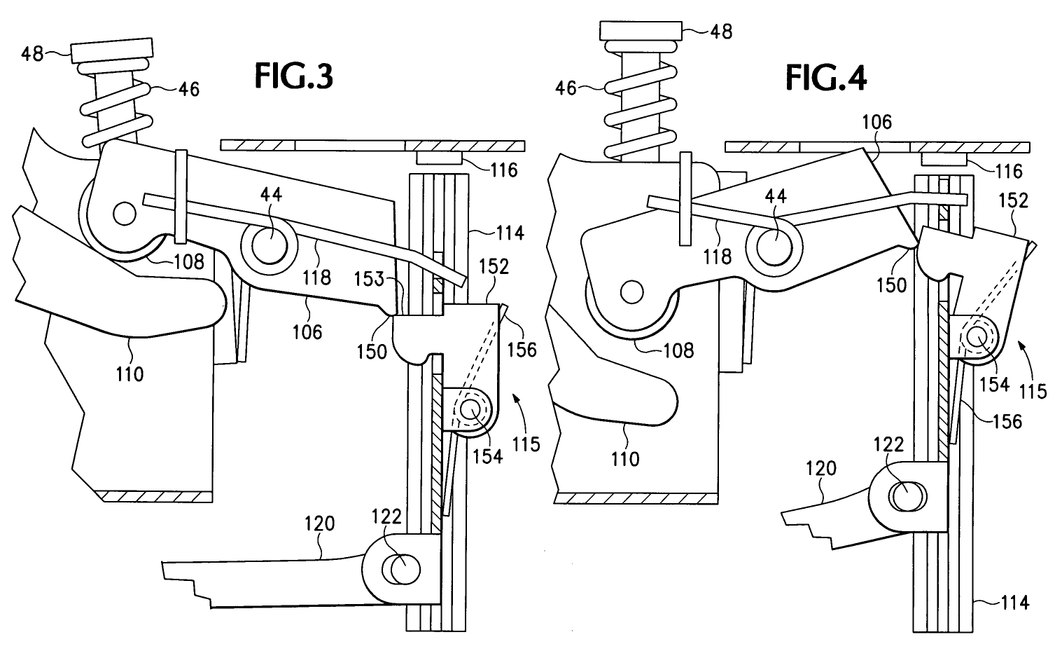

As rotation of the clinch driver progresses, the end of the clinch slide return spring 118 in engagement with the clinch slide plate 117 is deflected by the movement of the clinch slide plate and the energy stored in the spring increases. Referring to FIG. 3, the clinch driver 106 rotates about the magazine pin 44 and the portion of the clinch driver that is arranged to contact the return plate moves in an arc. On the other hand, the contact surface 153 of the return plate 152 translates on a chord of the arc proscribed by the contacting portion of the clinch driver. As the driver 42 and the transmission drive plate 60 reach the limits of their travel, the legs of the staple are pushed into the spaces between the anvil plates and the point of contact between the clinch driver and the return plate approaches the edge of the return plate and then disengages from the return plate. The clinch plate slide springs 118 release the stored energy by returning the clinch slide 115 to its initial position. The upward movement of the clinch slide rotates the transmission lever 120 counterclockwise, as viewed in FIG. 1, and the second end portion of the transmission lever is forced upward, contacting the clinching cam surfaces 92 of the clincher plates 86. The clinching surfaces 90 are rotated upward toward the clinched position. Referring to FIG. 7, since the handle has not been released, the driver 42 continues to bear on the crown of the staple and the interaction of the clinching surfaces 90 and the legs of the staple bend the legs toward the center of the crown and back toward the lower surface of the workpiece. Clinching is completed when the clinch slide returns to the initial position completing rotation of the clinching surfaces to the clinched position. When the clinch slide 115 fully returns to the initial position, the upper edge of the slide contacts a surface of the clinch slide stop 116 attached to the base producing an audible indication of the completion of the clinching of the staple.

Referring to FIG. 4, when the user releases the hand grip, the handle returns to its initial position under the influence of the handle spring. The upward movement of the handle pulls the driver and the transmission plate to their initial positions. The clinch driver return spring 104 urges the clinch driver lever 106 to rotate into contact with the transmission lever 110 and urges the transmission drive lever into contact with the transmission drive plate. When the clinch driver rotates toward the initial position, the end of the driver strikes a second contact surface on the underside of second portion of the return plate 152 rotating the hinged return plate and enabling the clinch driver to continue to rotate to its initial position. When the clinch driver has reached the initial position, the return plate spring 156 rotates the return plate toward the clinch slide plate so that the first contact surface 153 is aligned for engagement with the clincher driver in preparation for the next stapling cycle. To prevent staples or other debris from interfering with operation of the clincher, the clinching surfaces 90 are maintained in the clinched position by the clinch slide return springs until the user again pushes down on the handle to initiate a stapling cycle.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A stapler comprising:
(a) a clincher plate including a clinching surface arranged to engage a leg of a staple projecting substantially normal to a crown of said staple, said clinching surface movable from an unclinched position to a clinched position; and
(b) a clincher plate transmission arranged to move said clinching surface from said clinched position to said unclinched position in coordination with movement of a leg of a staple to a position where a portion of said leg is engageable by said clinching surface and then move said clinching surface to said clinched position.

2. The stapler of claim 1 wherein said clincher plate transmission comprises:
(a) a transmission lever including an end portion engageable with said clincher plate and movable to urge said clinching surface to said clinched position and, alternatively, to urge said clinching surface to said unclinched position;
(b) an energy storage device connected to said transmission lever and arranged to accumulate energy as said transmission lever is moved to urge said clincher plate to said unclinched position; and
(c) a driver engageable with said transmission lever to move said clinching surface to said unclinched position while urging a leg of a staple to a position where a portion of said leg is engageable by said clinching surface, said driver disengaging from said transmission lever when said leg of said staple is in said position for engagement by said clinching surface.

3. The stapler of claim 1 wherein said clinching surface is movable from an unclinched position angularly acute to said crown of said staple to a clinched position substantially parallel to said crown of said staple.

4. The stapler of claim 2 wherein said clincher plate further comprises:
(a) a clincher plate pivot enabling rotation of said clinching surface from said unclinched position to said clinched position;
(b) a clinching cam surface engageable by a first surface of said transmission lever; and
(c) a retraction cam surface spaced apart from said clinching cam surface and engageable by a second surface of said transmission lever.

5. The stapler of claim 2 wherein one of said energy storage device and said transmission lever is arranged to audibly signal movement of said clinching surface to said clinched position.

6. The stapler of claim 2 wherein said driver further comprises:
(a) a clinch driver including an engaging portion arranged to pivot as a leg of a staple is urged to a position where said leg is engageable by said clinching surface; and
(b) a clinch slide drivingly connected to said transmission lever and including a contact surface arranged to engage a portion of said clinch driver, said contact surface restrained to translate along a chord of an arc proscribed by said engaging portion of said clinch driver, said clinch driver disengaging from said clinch slide when said leg of said staple is in position for engagement by said clinching surface.

7. The stapler of claim 6 wherein said driving connection of said clinch slide and said transmission lever comprises an idler lever having a first end portion connected to said clinch slide and a second end portion connected to said transmission lever, said idler lever arranged to pivot about a point approximately intermediate between said first and said second end portions.

8. The stapler of claim 6 wherein at least one of said clinch slide and said energy storage device is arranged to emit an audible indication of movement of said clinching surface to said clinched position.

9. The stapler of claim 6 wherein said clinch slide comprises:
(a) a slide plate mounted for translation in said base and drivingly connected to said clincher plate;
(b) a return plate pivotally connected to said slide plate and including a first contact surface and a second contact surface engageable by said rotatable clinch driver, engagement with said first contact surface urging said return plate to a driving position enabling translation of said slide plate from a first position to a second position and engagement with said second contact surface rotating said return plate to disengage said clinch driver and said return plate; and
(c) an elastic member to urge said return plate to said driving position.

10. A stapler comprising:
(a) a base;
(b) a clincher plate pivotable in said base and including a clinching surface arranged to engage a leg of a staple protruding from a surface of a workpiece, said clinching surface movable from a clinched position to an unclinched position in coordination with penetration of said workpiece by a leg of a staple and then movable to said clinched position to clinch said leg of said staple;
(c) a clinch slide mounted in said base for translation and drivingly connected to said clincher plate so that said clinching surface is moved from said clinched position to said unclinched position by movement of said clinch slide from said first position to said second position;
(d) a clinch slide return spring elastically urging said clinch slide toward said first position; and
(e) a clinch driver pivotally mounted on said base and rotatable by a driver movable to urge a leg of a staple to pierce said workpiece, said clinch driver arranged to engage said clinch slide in said first position and cause said clinch slide to translate from a first position to a second position, said clinch driver disengaging from said clinch slide when said clinch slide reaches said second position.

11. The stapler of claim 10 wherein said driving connection of said clinch slide and said clincher plate comprises:
(a) a transmission lever pivotally attached to said base and having a first end portion including a first surface engageable with a clinching cam surface of said clincher plate and movable to pivot said clinching surface to said clinched position and a second surface engageable with a retracting cam surface of said clincher plate and movable to pivot said clinching surface to said unclinched position; and
(b) an idler lever pivotally attached to said base and having first end pivotally connected to said clinch slide and second end pivotally connected to a second end of said transmission lever.

12. The stapler of claim 10 wherein said clinch slide comprises:
(a) a slide plate mounted for translation in said base and drivingly connected to said clincher plate;
(b) a return plate pivotally connected to said slide plate and including a first contact surface and a second contact surface engageable by said rotatable clinch driver, engagement of said first contact surface by said clinch driver rotating said return plate to a driving position enabling translation of said slide plate from said first position to said second position in response to rotation of said clinch driver and engagement of said second contact by said clinch driver rotating said return plate to enable disengagement of said clinch driver and said return plate; and
(c) an elastic member to urge said return plate to said driving position.

13. The stapler of claim 10 further comprising:
(a) a displaceable driver arranged to engage and displace a crown of a staple causing a leg of said staple to pierce a workpiece;
(b) a transmission plate pivotally connected to said base and having a first end portion movable in response to displacement of said driver and a second end portion; and
(c) a roller rotatably attached to a first end of said clinch driver and arranged to engage a surface of said transmission plate, rotation of said transmission plate rotating said clinch driver.

14. The stapler of claim 10 wherein at least one of said clinch slide and said clinch slide return spring is arranged to audibly signal movement of said clinching surface to said clinched position.

15. A stapler comprising:
(a) a base;
(b) an anvil affixed to said base and including a support for a workpiece to be stapled;
(c) a clincher plate pivotally attached to said anvil and including a clinching surface movable from a clinched position substantially parallel to said workpiece support of said anvil to an unclinched position angularly depressed from said workpiece support;
(d) a transmission lever pivotally attached to said base and including a first end portion having a first surface arranged to engage said clincher plate and to urge said clinching surface to said clinched position and a second surface arranged to engage said clincher plate and urge said clinching surface to said unclinched position and a second end portion;
(e) an idler lever pivotally attached to said base and including a second end portion pivotally attached to said transmission lever and a first end portion;
(f) a clinch slide arranged to translate in said base between a first position and a second position and pivotally attached to said first end of said idler lever;
(g) an energy storage device connected to said clinch slide and arranged urge said clinch slide toward said first position and to accumulate energy when said clinch slide is moved from said first position to said second position;
(h) a clinch driver rotatable in said base and including a portion engageable with said clinch slide, rotation of said clinch driver displacing said clinch slide from said first position to said second position, said clinch driver disengaging from said clinch slide when said clinch slide is moved to said second position;
(i) a transmission lever rotatable in said base and including a surface engageable with said clinch driver to rotate said clinch driver; and
(j) a driver arranged to force a leg of a staple to pierce a workpiece supported on said surface and to rotate said transmission lever.

16. The stapler of claim 15 wherein at least one of said clinch slide, said idler lever and said clinch slide return spring is arranged to audibly signal movement of said clinching surface to said clinched position.

17. The stapler of claim 15 wherein clinch driver comprises:
(a) a clinch driver lever pivotally mounted in said base and engageable with said clinch slide; and
(b) a roller rotatably attached to said clinch driver lever and arranged to engage said surface of said transmission lever.

18. The stapler of claim 15 wherein said clinch slide comprises
(a) a slide plate arranged to translate in said base and pivotally attached to said idler lever;
(b) a return plate pivotally attached to said slide plate and including a first contact surface for engagement by said portion of said clinch driver and a second contact surface arranged for engagement by another portion of said clinch driver, engagement of said first contact surface urging said return plate into contact with said slide plate and enabling translation of said slide plate in response to rotation of said clinch driver and engagement of said second contact surface urging said return plate to rotate to disengage from said clinch driver; and
(c) a return spring urging said return plate to rotate into contact with said slide plate.

19. The stapler of claim 15 wherein said clinching surface of said clincher plate is movable from a clinched position substantially co-planar with said workpiece support.
